(19) United States
(12) Patent Application Publication
(10) Pub. No.: US 2004/0117459 A1
(43) Pub. Date: Jun. 17, 2004

(54) System and method providing multimedia messaging in communication networks

(76) Inventor: George Fry, Coppell, TX (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/316,919

(22) Filed: Dec. 12, 2002

(51) Int. Cl. G06F 15/16

(52) U.S. Cl. 709/219

(57) ABSTRACT

The invention provides a method and system for a network having multimedia messaging service (MMS) capability allowing downloading of one or more multimedia messages (MMs) from a server to a client. The client and/or the server is capable of generating commands for suspending and resuming downloading of the multimedia message. When the client or server generates a command for suspending a current downloading of a multimedia message, the server suspends the downloading of the multimedia message, and a marker is generated for marking the position of suspending the multimedia message. When the client or server generates a command for resuming the suspended downloading of the multimedia message, the server resumes the downloading from the position of suspending marked by the marker. The client when receiving additional subsequent portions of the multimedia message after generating a marker for marking the position of suspending the multimedia message, stores these additional subsequent portions of the multimedia message, generates a new marker pointing to the end of the received additional subsequent portions of the multimedia message, and stores the new marker.

### FIELD AND BACKGROUND OF THE INVENTION

The present invention relates to a system and method allowing multimedia messaging (MM) in a communication network. More specifically, the invention relates to downloading of multimedia messages, in particular in mobile multimedia messaging systems. Further, the invention relates to a client and server suitable for use in MM messaging.

A recent development in mobile messaging is called Multimedia Messaging Service, or MMS for short. MMS allows e.g. mobile phone users to incorporate audio, images, and other rich content with traditional text messages. The Multimedia Messaging Service provides the ability to send such messages comprising e.g. a combination of text, sounds, images and video to MMS capable handsets. MMS can transmit such messages containing text, graphics, photographic images, audio and even video clips between e.g. mobile devices using MMS standard or protocol, e.g. employing Wireless Application Protocol (WAP) as bearer technology powered by the high-speed transmission technologies EDGE and GPRS.

In more detail, the Multimedia messaging service (MMS) specification of 3GPP consists of three 3GPP Technical Standards (TSs); 3GPP TS 22.140, 3GPP TS 23.140 and 3GPP TS 26.140, which are incorporated herein by reference in their entirety. The TS 3GPP TS 22.140 provides a set of requirements which shall be supported for the provision of non real-time multimedia messaging service, seen primarily from the subscriber's and service providers' points of view. The TS 23.140 identifies the functional capabilities and information flows needed to support the MMS. The TS 26.140 provides the details of media types, formats and codecs used by the MMS service.

Some multimedia messages can be quite large, requiring significant time to download over wireless channels. Multimedia messages must be delivered in their entirety before the client, e.g. a mobile client can display them. A wireless multimedia subscriber may be in a situation where he/she needs to turn off, during downloading of a multimedia message, their mobile device, e.g., when boarding an airplane, running out of battery, etc. In this case, the multimedia message is cancelled in its entirety and the subscriber loses that portion of the multimedia message that had already been delivered.

Further, the subscriber may be billed for that portion of the message that was received, the time to download that portion of the message, or both. The subscriber will have to restart downloading of the multimedia message content from the beginning when the earlier conditions preventing complete downloading have been removed. Upon resumption of a terminated multimedia session, redundant transmissions take place which increase costs to the user, require excess capacity over the wireless link, and waste time.

As an alternative, the user would be forced to wait for the full message to be completely delivered.

For downloading files to computers via Internet, download managers such as GetRight are known which allow suspending and resuming a download process. However, such downloading managers are not applicable with respect to a mobile environment. For example, system requirements for GetRight applications require, for one version, a Microsoft-based operating system such as Microsoft Windows XP or NT 4.0, and high minimum hard drive space of more than 2 MB, a processor type of Intel Pentium, minimum RAM size 32 MB, and interface devices such as a mouse and modem. However, in a mobile device, resources are limited.

### SUMMARY OF THE INVENTION

The invention solve the above problems.

The invention provides a solution for downloading messages and/or set(s) of messages by allowing suspending and resuming of the multimedia message downloading. A multithread downloading with resuming capability is provided based on e.g. MMS specification.

Further, the invention provides a client and server suitable for use in MM messaging.

According to a preferred implementation of the invention, in mobile multimedia messaging systems, upon receipt of a command to suspend multimedia message delivery by an application server from a mobile terminal, the point of termination in the multimedia message is marked, and message transmission is halted. Although the message delivery is suspended, the session may be continued. That way, it is possible for the user to start downloading of another message, start a call or the like. It is also possible to terminate the session after suspending the message delivery. Thereafter, the network resources reserved for the session and message delivery may be released. It is of advantage to release these resources, in particular costly resources, in terms of reducing the overall network loading, connection costs etc. The release of resources may preferably be effected after checking that no other activity is required for this session. However, when other activities are intended or required for this session, the reserved resources may be maintained, i.e. not released.

This feature of release of network resources is preferably but not necessarily provided for a mobile network, method, or system in accordance with the invention. This feature is preferably integrated with the suspend and resume function. It may be implemented by arranging and structuring the MM server to automatically send, in response to receipt of a suspend command, a command to the wireless network to release resources. As an alternative, a separate signal, or even the same signal, may be sent to the wireless network from the MM server, or from the mobile, to inform the wireless network that it can release the network resources.

Upon reactivation by the mobile, the application server resumes transmission from that marked point where the multimedia message was suspended. Thus, upon resumption of a suspended multimedia message, no redundant transmissions are necessary. No increase of costs to the user occurs, no excess capacity over the wireless link is needed, and no time is wasted.

The invention does not require a complex structure and provides significant advantages e.g. with regard to service to the customer and reducing traffic over the link. In particular but not exclusively, the invention can be used in and for multi-media messaging service for 3GPP (Third Generation Partnership Program) and for 3GPP2 (Third Generation Partnership Program 2). 3GPP2 has adopted 3GPP MMS for its multimedia messaging solution. Thus, the invention applies to 100% of the global third generation wireless systems.

The invention offers many benefits to the multimedia messaging subscriber. First, the invention allows the subscriber to economize multi-media messaging service (MMS) system costs by minimizing the amount of data transmitted to the MMS client. Second, the invention saves the subscriber time in downloading multi-media messages (MMs) by eliminating the need to retransmit portion's of messages already received. Third, the invention optimizes the operator's network utilization by preventing needless retransmission of portions of MMs, enabling network capacity to be allocated to other uses.

Although in a mobile device resources are limited, the necessary system and/or software requirements for implementing the invention are low enough to allow implementation of the necessary functions and means in a mobile device. The invention's efficient approach enables suspend and resume procedures in the wireless world.

The invention with all its embodiments and/or variations and/or combinations can be applied to messages and/or to sessions that may carry multimedia content.

### BRIEF DESCRIPTION OF THE DRAWINGS

FIG. 1 shows an embodiment of a user equipment used in and to implement, at least partly, the present invention;

FIG. 2 illustrates features of, and messages and information exchanged between, an MM server and an MM client when suspending and resuming download of an MM message; and

FIG. 3 illustrates an embodiment of the present invention and in particular shows a routine running on the MM server.

### DETAILED DESCRIPTION OF PREFERRED EMBODIMENTS OF THE INVENTION

Below, several solutions are described allowing suspending and resuming of downloading of messages.

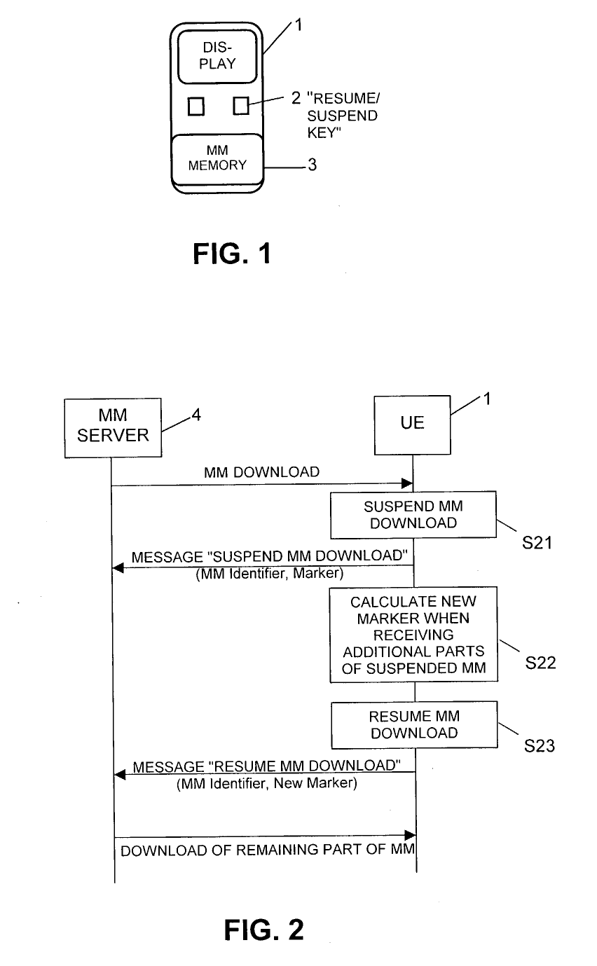

FIG. 1 shows an embodiment of an MM client which is implemented as a mobile user equipment (UE) 1 such as a mobile phone or mobile computer (e.g. laptop) including a communication part. The UE 1 includes a customary equipment such as display etc, and additionally comprises one or more keys 2 for allowing a user to input suspend and resume commands for commanding suspending of downloading of a message, in particular a MM, and resuming of a suspended downloading.

The term multimedia message (MM) designates a message in accordance with the MMS specification mentioned above.

The UE 1 further comprises a MM memory 3 for storing partially and/or fully downloaded messages. The suspend and resume commands may be input via the same key 2 which may be implemented to toggle between the suspend and resume commands, e.g. a first actuation of the key 2 during downloading of a MM message is interpreted by the UE software as a suspend command whereas the second actuation of the key 2 is interpreted as a resume command. The key 2 may also have other functions when actuated outside of a MM download process, and may e.g. be implemented as a call terminating key. Alternatively, the UE 1 may have separate keys for inputting the suspend and resume commands.

The embodiments of the invention preferably pertain to multimedia message services (MMS). The embodiments include exchange of signals between a, preferably mobile, multimedia messaging client and a multimedia messaging server that allow delivery of a multimedia message (MM) to be suspended and resumed at a later time. Included is a method of marking the place in the multimedia message where transmission has been suspended in order to know where in the message a transmission to the mobile multimedia messaging client is to be resumed.

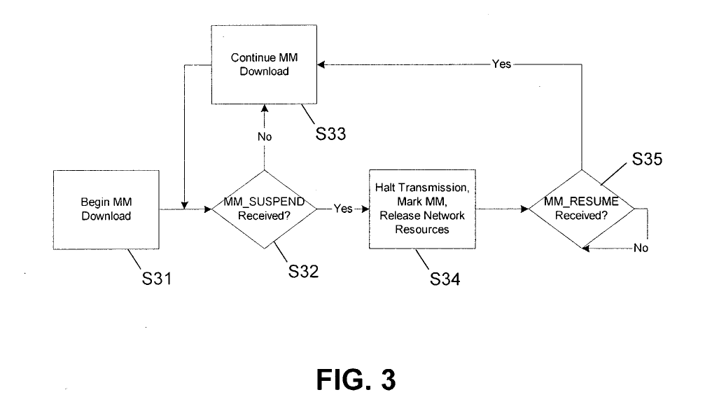

FIGS. 2 and 3 depict the exchange of messages and a flow chart of the system operation at the MM (Multimedia Message) server 4 and client 1, once the MM client, i.e. the mobile UE 1 in this embodiment, has requested and initiated transmission of the MM. The flow chart pertains to the processes applied to a single MM. The MM server 4, while transmitting the MM, is able to receive signals from the MM client 1. One such signal may be a suspend command, e.g. of the form MM_SUSPEND, indicating that the MM client 1 wishes to suspend transmission of the MM.

When the client 1 or server 4 generates a command for suspending a current downloading of the multimedia message, this command is transmitted to the server or client respectively.

The MMS (MMS=Multimedia Messaging System) consists of a MM client 1, a wireless network, and a MM server 4. The MM client 1 requests download of a MM from the MM server 4. The MM server 4 begins downloading as shown in FIG. 2 and FIG. 3, step S31. After the MM server 4 has commenced transmission of the MM to the MM client 1 e.g. in the form of data packets such as via GPRS, the MM client 1 stores the received packets or portions of the MM in the memory 3 after properly concatenating the received packets or portion to the original form of the multimedia message.

As mentioned above, the MMS system and function may include or consist of a MM Client, a wireless network, and a MM server.

In another embodiment, the suspend and resume feature and function may be implemented in a component, for example radio network controller (RNC), of the wireless network which component is arranged between the MM server and the mobile. In this embodiment, the MM server can download the complete MM message to the component which is equipped with a download suspend and resume function when downloading the MM message from the component to the mobile terminal. The signaling and message flow between the component and the terminal for the download suspend and resume function is in this case the same as the signaling and message flow between the MM server and the terminal in the above mentioned case.

This embodiment with an additional component providing the downloading suspend and resume function is of advantage because there is no need that the MM server as such is to be upgraded or changed. For instance, when the MM server is a legacy element or proprietary server, the server can remain unchanged. The component in the wireless network acts as an additional server or proxy between the MM server and the terminal (client).

When the client 1 wishes to suspend the current download of the multimedia message as shown in FIG. 2, step S21, it issues a suspend signal, i.e. “SUSPEND MM DOWNLOAD” or MM_SUSPEND message, to the MM server 4, indicating its wish to suspend transmission of the current MM. The server 4 repeatedly or continuously checks receipt of the suspend command, step S32 of FIG. 3. When not receiving a suspend command, the routine proceeds to step S33, and the download of the multimedia message is continued.

In response to receipt of a suspend command detected in step S32, the MM server 4 proceeds to step S34, i.e. halts transmission of the MM, marks the place in the MM where transmission was suspended, and may release wireless network resources (e.g., RF channels, IP assignments, etc.) committed for the MM transfer.

The MM server 4 executes a wait loop as shown by block S35 and awaits receipt of a resume command signal, e.g. MM_RESUME signal, from the client 1, indicating that the MM client 1 wishes to resume delivery of the previously suspended MM. When the MM_RESUME signal is received, the MM server 4 proceeds to step S33 and continues transmission of the MM from the place marked in the MM when the MM_SUSPEND signal was received.

The invention is preferably implemented in software as a set of signals exchanged between a MM client and a MM server. For example, one such signal is the suspend signal, e.g. MM_SUSPEND, sent from the MM client 1 to the MM server 4 to halt transmission of the current MM. The resume signal, MM_RESUME, will be sent from the MM client to the MM server indicating that the client wishes to resume downloading of the previously suspended MM.

The present invention places minimal additional system requirements on the mobile terminal. Implementation of messaging software to recognize and parse MM_SUSPEND and MM_RESUME signals, as well as protocol logic within the mobile terminal's MMS application software, are estimated at less than 1000 bytes. User interface software enhancements are of the same order of complexity. Suspend and resume protocol logic would fit cleanly into known embodiments of current MMS systems, precluding complex and costly software restructuring. Additional memory is needed to store a marker on the mobile terminal for each MM, but this represents only a few bytes per message.

In the following, additional embodiment details are described.

A first embodiment scenario deals with User Initiated Suspend. The user e.g. of client 1 may initiate this scenario at any point after multimedia message (MM) downloading has started. The decision of the user to suspend information downloading after it has started could be for any reason, e.g., boarding a plane, other, higher priority message in the queue, time (and cost) to download being too high, etc. He/she presses a pre-configured Suspend button 2. This button can be implemented as a softkey implementation as in the Mute key during a voice call.

The MM client may be configured in a mobile phone such as user equipment, or on a (preferably portable) computer device such as a laptop or PDA. The wireless access in particular when implementing the MM client on a computer device is effected through another device like an IEEE802.11 or cellular modem card, or a cellular phone is acting as a cellular modem, or an integrated WLAN or cellular modem circuitry, etc.

The Suspend function is implemented in the MM client software e.g. on the laptop or PDA, and includes generation of the suspend signal, maintaining the partially downloaded message in the memory 3 at least during the suspend interval. The Suspend function is integral to the MM client software, regardless of where that software is running. Furthermore, a wireless connection is not required. The MM client may be connected to the MM server over a dial up connection, cable or DSL connection, or over wired ethernet in a corporate intranet.

The invention provides a protocol enhancement between the client and the server, in particular by adding suspend and resume commands to the protocol, in particular the protocol supporting MMS. The underlying and intermediary network elements are not players in this protocol.

The software in the client terminal, e.g. UE 1, marks the place in the message where it wants to resume delivery at a later date. The following are examples of methods to determine the position of the marker which marks the place of resuming in the message:

One method to establish the marker position is to count and store the number of bytes from the beginning of the MM that the client has successfully received (e.g. having passed a CRC check). The marker is represented in this case by this number of bytes.

Another method is to mark a convenient or efficient location in the message. For example, if it is known that the entire message must be segmented for transmission, and is transmitted in the form of two or more segments of e.g. several kilobytes, for instance 30 Kb each, the marker can be placed at a defined or convenient location relative to such message segmentation boundaries, e.g. at the nearest boundary between such received segments. The defined location relative to the boundaries can be the location of the boundary between the last received segments, or at the end of the last received segment if completely received in case no new segment has yet started to be received. The marker thus indicates the boundary of the last segment successfully and completely received by the client before suspending the multimedia message downloading. This is an optimization of the marker positioning method.

Once the MM client 1 has set the marker in the MM, it stores that marker for future use e.g. in the MM memory 3, and sends a suspend message, e.g. MM_SUSPEND_REQUEST, to the MM server 4. Among the information that is contained in this suspend message is an identifier identifying the multimedia message MM, e.g. the MM id, and marker, e.g. the value of the suspend marker. As mentioned above, the value can e.g. indicate the number of bytes successfully received before the suspend process, or the last segment received. The MM client 1 may ignore any additional portions of the MM that are delivered thereafter. The original value of the marker is used.

In a more advanced efficient embodiment, the MM client 1 will not ignore additional bytes received from the server 4 after setting the marker and generating the suspend command. These additional bytes may be appended to the MM portion already delivered and stored in the MM memory 3, as shown in FIG. 2, step S22. In this case, the client 1 will again calculate and reset the marker accordingly so as to point to, that is indicate, the end of the additional received and stored bytes which corresponds to the end of the successfully received portion of the multimedia message. This new marker will be stored in the UE 1, and may additionally be sent to the server 4 immediately or with the next resume command.

This calculation of a new marker provides the advantage of taking into account also such portions, e.g. packets, of the multimedia message which are actually generated by the server or are transported on the transmission path between the server and the client at the time when deciding to suspend the multimedia message download.

Such portions hence need not be transmitted a second time after resuming the suspended download, leading to a reduction of the overall download time and the necessary processing load, transmission resources etc.

This feature of calculating and using a new marker can also be applied to a message system which is not restricted to, or might even be unable to transmit, multimedia messages and may e.g. only be suitable for transmitting non-multimedia messages or files. A method, system, server, or client in accordance with this implementation of the invention can e.g. be characterized as follows: Method, system, server, or client for a network having messaging capability allowing downloading of one or more messages from a server to a client, wherein the client and/or the server is capable of generating commands for suspending and resuming downloading of the message, when the client or server generates a command for suspending a current downloading of a message, the server suspends the downloading of the message, and a marker is generated for marking the position of suspending the message, and when the client or server generates a command for resuming the suspended downloading of the message, the server resumes the downloading from the position of suspending marked by the marker. Preferably, when the downloading is suspended, the client and the server generate markers for marking the position of suspending the message, and store the markers, wherein the client when receiving additional subsequent portions of the message after generating the marker, stores these additional subsequent portions of the message, generates a new marker pointing to the end of the received additional subsequent portions of the message, and stores the new marker.

In the above described embodiments, it is not necessary that the suspend command includes the marker. In this case, only the resume command includes the generated marker, e.g. the updated marker after additional pieces of the message were received.

After sending the suspend command to the server 4, the client, e.g. terminal, may release bearer resources to conserve battery power, reduce airtime connection charges, or to begin other tasks.

The MM server 4 parses the suspend command, i.e. the MM_SUSPEND_REQUEST message, halts transmission of the remaining portion of the multimedia message (MM) indicated by the identifier identifying the MM (e.g. the MM id), and marks the MM at the point described by the received marker. It then awaits receipt of a resume command, e.g. the MM_RESUME_REQUEST message containing the MM id of the suspended message.

The MM server 4 may send a MM_SUSPEND_ACK containing the MM identifier and the marker, to the client 1. This ensures that the MM client 1 and MM server 4 agree on the point where MM delivery has been suspended. The server 4 is able to process other requests from the MM client 1, such as retrieve another MM.

When the user is ready to resume MM delivery, as shown in FIG. 2, step S23, he/she presses the pre-configured Resume key 2. This causes the MM client 1 to issue a resume command, i.e. “RESUME MM DOWNLOAD” or MM_RESUME_REQUEST message, to the MM server 4. This resume message preferably includes the marker as a way to ensure that the MM server 4 resumes transmission of the MM at the proper place (the previous marker may have been corrupted in transmission, or may have been changed due to the above described more advanced embodiment providing the option of adding additionally received bytes to the stored first part of the MM). This requires the marker to be stored by the client software for use in the MM_RESUME_REQUEST message. If the marker is not added to the resume command, the marker need not be stored in the client.

When the resume command, e.g. MM_RESUME_REQUEST, message is received, the MM server 4 may return an acknowledge, MM_RESUME_ACK, message containing the MM id and the value of the marker. The server then resumes transmission of the MM at the point described by the marker.

If the marker contained in the MM_RESUME_REQUEST message differs from that stored in the server 4, the marker in the MM_RESUME_REQUEST takes precedence. The MM server resumes MM delivery from the point described by the marker contained in the MM_RESUME_REQUEST message.

At this point the user is free to send another MM_SUSPEND_REQUEST message, and the above described process may be repeated.

In the same or another embodiment of the invention, the following additional or alternative functions and structures may be implemented. A suspend process can also be initiated by the MM server 4 in this embodiment.

For implementing the Server Initiated Suspend, the MM server 4 in the network is able to initiate this suspend process at any point after MM downloading has started. The server 4 may want to suspend MM delivery for a variety of reasons, including but not limited to, network congestion, memory paging needs, fault-tolerant side switching maintenance actions, prepaid account depletion, etc.

During downloading of a MM, the server may repeatedly check the set conditions for suspending a current download, and/or may respond to an input command informing it on the need to suspend the downloading, and determines based thereon on the need to halt or suspend downloading. When the server 4 determines that MM delivery should be suspended, it marks, by generating and storing a marker, the place in each downloading MM where it is to be suspended. This may be a single MM to a single client (as in the prepaid account depletion example) or it may be to some or all active MM clients 1 that are downloading MMs (as in the fault-tolerant side switching maintenance action). For each MM to be suspended, the server 4 issues a suspend command, e.g. a MM_SUSPEND_REQUEST, containing the MM id and the marker. This suspend command is sent to the client which stores the MM id and the marker in addition to those portions of the actually downloaded multimedia message which had already been received.

Each MM client 1 preferably replies with a MM_SUSPEND_ACK message that acknowledges to the MM server 4 that the client 1 knows that message delivery has been suspended. The information in the MM_SUSPEND_ACK preferably includes the MM ID and the marker to ensure that the MM client and MM server agree on the place where MM delivery has suspended.

At this point, the terminal, i.e. the client 1, may release bearer resources to conserve battery, reduce airtime connections charges, or move on to other tasks. The server 4 may also release the transmission resources such as the bearer resource.

When the conditions that caused the MM server 4 to suspend message delivery have been satisfied or resolved, the MM server 4 decides to resume MM delivery of the one or all suspended MMs. The server 4 preferably issues a resume command, e.g., MM_RESUME_REQUEST command, to each MM client 4 that has suspended MMs. Information contained in the MM_RESUME REQUEST includes the MM id and the marker, indicating where the MM server 4 will resume MM delivery.

Once the MM client 1 receives the resume command MM_RESUME_REQUEST, one of two methods may be employed:

The MM client 1 may be configured to automatically resume MM download. In this case, the MM client 1 may issue to the server 4 an acknowledge message, MM_RESUME_ACK, containing the MM id and the marker. MM download is resumed by the server 4 from the point indicated by the marker in the acknowledge message.

The MM client 1 may also be configured to seek user interaction before continuing. In this case, a notification is displayed to the user that a MM is ready to resume downloading. The user has the choice to continue or delay resumption of the download operation. The user may e.g. actuate the resume button 2 when he wishes to continue the downloading operation.

If the marker stored in the server during the suspending process and sent by the server 4 to the client 1 in the resume command, and the marker stored in the client 1 do not coincide, the marker stored in the MM client 1 has preference and overrides that in the server 4. The MM client 1 issues and transmits to the server 4 an acknowledge message, e.g. MM_RESUME_ACK, containing the new marker, i.e. the marker stored in the client 1 for the suspended multimedia message. The MM server 4 resumes MM delivery from the marker contained in the acknowledge message MM_RESUME_ACK, and continues MM transmission until the MM is completely delivered.

In a preferred embodiment, the client is a mobile client, preferably a user equipment, having an input for inputting suspend and resume commands. The client does not necessarily have to be a mobile client, and may also take other forms, e.g., personal digital assistant (PDA), conventional computer, or any other device that is capable of functioning as a MM client as described in this invention.

The downloading may be effected via a wireless channel, in particular when the client is a mobile client, preferably a user equipment. The channel does not necessarily have to be a wireless channel, and may also be a non-wireless channel as in the case of e.g. DSL, cable, or ethernet cable on a corporate intranet. In the latter case, the downloading is effected via a non-wireless channel.

Although preferred embodiments have been described above, the invention is not limited thereto and may also be implemented in other ways, e.g. by combining, in any arbitrary fashion, one or more features of one or more embodiments with one or more features of other embodiments. As an example, the method and system in accordance with any of the above mentioned features of the invention may be implemented in or be applied to a network having normal messaging service capability, i.e. non-multimedia messaging service capability, allowing downloading of one or more non-multimedia messages, e.g. pure text messages, or files from a server to a client which need not be a mobile client. Further, the downloading of messages may also be effected via a wire-bound link instead of a wireless channel.

1. A method for a network including multimedia messaging service capability allowing downloading of one or more multimedia messages from a server to a client, comprising:
at least one of the client and the server generates commands for suspending and resuming downloading of the multimedia message;
when the client or server generates a command for suspending a current downloading of a multimedia message, the server suspends the downloading of the multimedia message, and a marker is generated for marking the position of suspending the multimedia message; and
when the client or server generates a command for resuming the suspended downloading of the multimedia message, the server resumes the downloading from the position of suspending marked by the marker.

2. A method according to claim 1, wherein:
when the downloading is suspended, the client and the server generate markers for marking the position of suspending the multimedia message, and store the markers.

3. A method according to claim 2, wherein:
the client when receiving additional subsequent portions of the multimedia message after generating the marker, stores the additional subsequent portions of the multimedia message, generates a new marker pointing to the end of the received additional subsequent portions of the multimedia message, and stores the new marker.

4. A method according to claim 1, wherein:
the client when generating or receiving a command for resuming the suspended downloading of the multimedia message, transmits the marker, or the client generates the new marker and transmits the new marker to the server, and the server resumes the downloading from the position indicated by the transmitted marker.

5. A method according to claim 1, wherein:
an entire message is transmitted in a form of segments, and the marker is placed at a defined location relative to boundaries of received segments.

6. A method according to claim 5, wherein:
the defined location relative to the boundaries is the location of the boundary at the end of the last completely received segment.

7. A method according to claim 1, wherein:
at least one of the server and the client releases network resources for transmission when receiving a command for suspending the downloading of a multimedia message.

8. A method according to claim 1, wherein:
the client is a mobile client and includes an input for inputting suspend and resume commands.

9. A method according to claim 1, wherein:
the downloading is effected via a wireless channel.

10. A method according to claim 1, wherein:
the downloading is effected via a non-wireless channel.

11. A method according to claim 1, wherein:
the server is a network component disposed between a multimedia message (MM) server and the client.

12. A system including multimedia messaging service capability allowing downloading of one or more multimedia messages from a server to a client, comprising:
at least one of the client and the server generates commands for suspending and resuming downloading of the multimedia message;
when the client or server generates a command for suspending a current downloading of a multimedia message, the server suspends the downloading of the multimedia message[,] and at least one of the client and server generates a marker for marking the position of suspending the multimedia message; and
when the client or server generates a command for resuming the suspended downloading of the multimedia message, the server resumes the downloading from the position of suspending marked by the marker.

13. A system according to claim 12, wherein:
when the downloading is suspended, the client and the server generate markers for marking the position of suspending the multimedia message and store the markers.

14. A system according to claim 13, wherein:
the client stores, when receiving additional subsequent portions of the multimedia message after generating the marker, the additional subsequent portions of the multimedia message, to generate a new marker pointing to an end of the received additional subsequent portions of the multimedia message, and stores the new marker.

15. A system according to claim 12, wherein:
the client transmits, when generating or receiving a command for resuming the suspended downloading of the multimedia message, the marker, or the client generates the new marker and transmits the new marker to the server, and the server resumes the downloading from the position indicated by the transmitted marker.

16. A system according to claim 12, wherein:
an entire message is transmitted in a form of segments and the marker is placed at a defined location relative to the boundaries of the received segments.

17. A system according to claim 16, wherein:
the defined location relative to the boundaries is the location of the boundary at the end of the last completely received segment.

18. A system according to claim 12, wherein:
at least one of the server and client release network resources for transmission when receiving a command for suspending the downloading of a multimedia message.

19. A system according to claim 12, wherein:
the client is a mobile client and includes an input for inputting suspend and resume commands, and the downloading is effected via a wireless channel.

20. A system according to claim 12, wherein:
the system effects the downloading via a non-wireless channel.

21. A system according to claim 12, wherein:
the server is a network component disposed between a multimedia message (MM) server and the client.

22. A client including multimedia messaging service capability allowing downloading of one or more multimedia messages from a server to the client, wherein:
the client generates commands for suspending and resuming downloading of the multimedia message;
the client generates, when generating or receiving a command for suspending a current downloading of a multimedia message, a marker for marking the position of suspending the multimedia message; and
the client transmits the marker to the server when the suspended downloading of the multimedia message is to be resumed.

23. A client according to claim 22, wherein:
the client is stores, when receiving additional subsequent portions of the multimedia message after generating the marker, the additional subsequent portions of the multimedia message, to generate a new marker pointing to the end of the received additional subsequent portions of the multimedia message, and stores the new marker.

24. A client according to claim 23, wherein:
the client transmits, when generating or receiving a command for resuming the suspended downloading of the multimedia message, the new marker to the server for resuming the downloading from the position indicated by the transmitted marker.

25. A client according to claim 22, wherein:
the client releases network resources for transmission after generating or receiving a command for suspending the downloading of a multimedia message.

26. A client according to claim 22, wherein:
the client is a mobile client and includes an input for inputting suspend and resume commands.

27. A server including multimedia messaging service capability allowing downloading of one or more multimedia messages from the server to a client, wherein:
the server generates commands for suspending and resuming downloading of the multimedia message; and
the server generates, when generating or receiving a command for suspending a current downloading of a multimedia message, a marker for marking the position of suspending the multimedia message.

28. A server according to claim 27, wherein:
the server compares the generated marker with a marker received from the client when a suspended downloading of the multimedia message is to be resumed, and resumes the downloading from the position marked by the marker received from the client when the compared marker should be different.

29. A server according to claim 27, wherein the server releases network resources after suspending the downloading of a multimedia message.
